(19) United States
(12) Patent Application Publication
(10) Pub. No.: US 2025/0062434 A1
(43) Pub. Date: Feb. 20, 2025

(54) BATTERY THERMAL MANAGEMENT

(71) Applicant: CPS Technology Holdings LLC, New York, NY (US)

(72) Inventor: Jason D. FUHR, Sussex, WI (US)

(21) Appl. No.: 18/720,229

(22) PCT Filed: Jan. 3, 2023
(86) PCT No.: PCT/US2023/060021

§ 371 Date: Jun. 14, 2024

Related U.S. Application Data
(60) Provisional application No. 63/297,020, filed on Jan. 6, 2022.

(51) Int. Cl. H01M 10/613; H01M 10/647; H01M 10/6554; H01M 50/204

(52) U.S. Cl. CPC H01M 10/613; H01M 10/647; H01M 10/6554; H01M 50/204

(57) ABSTRACT

A thermal exchanger for a battery is described. The battery includes one or both of a first stack and a second stack of battery cells. The thermal exchanger includes a thermal exchanger leg portion and a thermal exchanger foot portion. The thermal exchanger leg portion is positionable to thermally couple to one or both of the first stack and the second stack of battery cells. Further, the thermal exchanger leg portion is arranged to transfer thermal energy from one or both of the first stack and second stack to the thermal exchanger foot portion.

### TECHNICAL FIELD

This disclosure relates to a method and system for battery thermal management.

### BACKGROUND

A variety of battery cells are available to power vehicles. For example, lithium-ion batteries are known to be provided as rechargeable batteries in electrical vehicles. Lithium-ion batteries generate high amounts of heat during operation, which can greatly deteriorate performance of the batteries. Many such battery systems use conventional fluid cooling systems, such as liquid cooling, in an effort to provide heat management capacity and efficiency.

However, conventional fluid cooling systems for rechargeable lithium-ion batteries encounter problems as these systems use complex technology. For example, conventional fluid cooling systems for lithium-ion batteries encounter problems with failure modes related to leaking radiators and problems associated with maintaining an optimal temperature range in battery packs. In addition, it is troublesome for these systems to provide uniform temperature distribution, which impacts performance of battery packs.

In sum, existing cooling systems are complex, use radiators that may leak fluid, and may not adequately provide cooling of batteries.

### SUMMARY

Some embodiments advantageously provide a method and system for battery thermal management.

According to one aspect, a battery cooling system is provided. The battery cooling system comprises a first stack of battery cells and a second stack of battery cells; and a thermal exchanger comprising a thermal exchanger leg portion and a thermal exchanger foot portion, the thermal exchanger leg portion being disposed between and thermally coupled to adjacent lateral sides of the first and second stacks, and the thermal exchanger leg portion comprising a leg length that extends from a top to a bottom of the adjacent lateral sides to transfer heat energy from the battery cells of the first and second stacks to the thermal exchanger foot portion, and the thermal exchanger foot portion being disposed within and thermally coupled to a cooling fluid flow channel defined by a battery housing, and the thermal exchanger foot portion comprising a cooling fin element configured to transfer heat energy from the thermal exchanger leg portion into the cooling fluid flow channel.

In some embodiments, the thermal exchanger leg portion has a planar surface shape. In some embodiments, the thermal exchanger foot portion has a non-planar waveform surface shape. In some embodiments, the thermal exchanger is a stamped thermally conductive structure.

According to another aspect, a radiator for a battery is provided. The radiator comprises a thermal exchanger comprising a thermal exchanger leg portion and a thermal exchanger foot portion, the thermal exchanger leg portion comprising a planar surface shape configured to be disposed between and thermally coupled to adjacent lateral sides of a first and a second stack of battery cells, and the thermal exchanger leg portion comprising a leg length configured to extend from a top to a bottom of the adjacent lateral sides to transfer heat energy from the battery cells of the first and second stacks to the thermal exchanger foot portion, and the thermal exchanger foot portion comprising a cooling fin element having a non-planar waveform surface shape configured to transfer heat energy from the thermal exchanger leg portion into a cooling fluid flow channel.

In some embodiments, the thermal exchanger foot portion and the thermal exchanger leg portion form an L-shaped structure. In some embodiments, the thermal exchanger foot portion extends away from the thermal exchanger leg portion in a first direction and the thermal exchanger further comprises a second thermal exchanger foot portion that extends away from the thermal exchanger leg portion in a second direction that is opposite to the first direction. In some embodiments, the thermal exchanger foot portions and the thermal exchanger leg portion form a T-shaped structure.

According to yet another aspect, a method of manufacturing and/or assembling a battery cooling system is provided. The method comprises providing the thermal exchanger of any one of the embodiments disclosed herein. The method further includes providing a battery housing, the battery housing being molded to define a leg portion receiver and at least part of a cooling fluid flow channel, the leg portion receiver sized, shaped and/or configured to receive a leg portion of the thermal exchanger therein and the at least part of the cooling fluid flow channel sized, shaped and configured to receive a foot portion of the thermal exchanger therein. The method further includes inserting the thermal exchanger into the battery housing to press fit the respective leg portion into the leg portion receiver between a first stack of battery cells and a second stack of battery cells and to include the foot portion in the at least part of the cooling fluid flow channel. The method further includes after inserting the thermal exchanger, assembling a base plate onto the molded battery housing to enclose the thermal exchanger in the battery housing.

According to one aspect, a thermal exchanger for a battery comprising one or both of a first stack and a second stack of battery cells is described. The thermal exchanger comprises a thermal exchanger leg portion and a thermal exchanger foot portion. The thermal exchanger leg portion is positionable to thermally couple to one or both of the first stack and the second stack of battery cells. The thermal exchanger leg portion is arranged to transfer thermal energy from one or both of the first stack and second stack to the thermal exchanger foot portion.

According to another aspect, a battery cooling system comprises one or both of a first stack of battery cells and a second stack of battery cells and a thermal exchanger. The thermal exchanger comprises a thermal exchanger leg portion and a thermal exchanger foot portion. The thermal exchanger leg portion is thermally coupled to the one or both of the first stack and the second stack of battery cells. The thermal exchanger leg portion is arranged to transfer thermal energy from one or both of the first stack and second stack to the thermal exchanger foot portion. The battery cooling system further includes a battery housing that defines at least part of a cooling fluid flow channel. The thermal exchanger and the one or both of the first stack and the second stack are positioned within the battery housing. The thermal exchanger foot portion is positioned within cooling fluid flow channel.

According to one aspect, a method of manufacturing a battery cooling system for a battery is described. The battery comprises a cooling fluid flow channel, a battery housing, and a first stack and a second stack of battery cells. The battery housing comprises a leg portion receiver. The battery cooling system comprises a thermal exchanger. The thermal exchanger includes a thermal exchanger leg portion and a thermal exchanger foot portion. The method comprises molding the battery housing to define the leg portion receiver and at least part of the cooling fluid flow channel. The leg portion receiver is arranged to receive the thermal exchanger leg portion of the thermal exchanger therein. The at least part of the cooling fluid flow channel being arranged to receive the thermal exchanger foot portion therein. The method further includes inserting the thermal exchanger into the battery housing by press fitting the thermal exchanger leg portion into the leg portion receiver between the first stack of battery cells and the second stack of battery cells and including the thermal exchanger foot portion in the at least part of the cooling fluid flow channel.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is an elevational, partial sectional side view of an example cooling system including a thermal exchanger inside a battery housing according to one embodiment of the present disclosure;

FIG. 2 is a perspective, partial side view of a stamped thermal exchanger outside of a battery housing according to one embodiment of the present disclosure;

FIG. 3 is a schematic diagram illustrating a plan view of a bottom of the cooling system according to one embodiment of the present disclosure;

FIG. 4 is a perspective view of the cooling system in an assembled arrangement including the battery housing and bottom plate according to one embodiment of the present disclosure;

FIG. 5 is a perspective side view of a second embodiment of a stamped thermal exchanger outside of a battery housing according to one embodiment of the present disclosure;

FIG. 6 is an elevational, partial sectional side view of a second example cooling system including the thermal exchanger of FIG. 5 inside a battery housing according to one embodiment of the present disclosure;

FIG. 7 is a schematic diagram illustrating a plan view of a bottom of the second example cooling system according to one embodiment of the present disclosure;

FIG. 8 is a flowchart illustrating an example method of manufacturing according to one embodiment of the present disclosure; and

FIG. 9 is a flowchart illustrating an example method of manufacturing according to one embodiment of the present disclosure.

### DETAILED DESCRIPTION

One or more embodiments provide a thermal management solution. In some embodiments, the thermal management solution provides an integrated, “molded in housing” thermal management solution. Some other embodiments provide a sealed, and efficient fluid (e.g., liquid) cooling solution. In some embodiments, the heat exchangers transfer heat from the battery cells to a fluid cooling path (e.g., using components) and without the complexity of over-molding. Some other embodiments provide individual heat exchangers in a cooling fluid (e.g., coolant) path which permits the heat exchangers to be placed within the cooling fluid to provide a substantially common average temperature.

It may also be possible, in some embodiments, to have a heat exchanger within the cooling fluid path that extends to high temperature electronics components.

Some embodiments provide a, efficient, sealed thermal management solution. Some embodiments provide a thermal management solution by using simple stamped heat exchanger(s) in proximity to the battery cells and within the cooling fluid path. Having at least a part of the formed heat exchanger within (i.e., directly contacting the fluid in) the cooling fluid path enables efficient thermal conduction of heat. At the same time, in some embodiments, since the cooling fluid path is molded into the battery housing and there is no direct contact path of the fluid to the battery cells (and/or high temperature electronics components), a safer solution (as compared to direct contact liquid cooling solutions) without the failure modes related to leaking radiators is provided.

In some embodiments, instead of having two heat exchangers for each set of battery cell stacks, the heat exchangers may be combined as a single, folded heat exchanger in an alternative embodiment, as described in more detail below.

Before describing in detail exemplary embodiments, it is noted that the embodiments reside primarily in combinations of apparatus components and processing steps related to battery thermal management. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term to “couple” (and/or coupled and/or coupling) is used and may refer to at least to joining, affixing, attaching, connecting, placing in contact, bringing in contact two or more elements or components. In some other embodiments, the term “thermally couple” is used and may refer to bringing one or more elements in contact with each other such that thermal energy may be exchanged between the elements. For example, a first element may be directly/indirectly in contact with a second element, where the first element is in contact with the second element and transfers thermal energy (e.g., heat) to the second element. The second element may be configured to receive the thermal energy and/or transfer the thermal energy to a third element. Thus, thermal coupling may refer to arranging elements such that the thermal conductivity of at least one of the elements can be used to achieve thermal energy exchange. For example, a thermal exchanger may be thermally coupled to a battery pack having a predetermined thermal energy (e.g., heat), where the thermal exchanger absorbs at least a portion of the thermal energy and transfers the thermal energy to a cooling fluid and/or cooling fluid flow channel. In this nonlimiting example, the thermal exchanger is thermally coupled to the battery pack, the cooling fluid, and cooling fluid flow channel.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the relevant art and will not be interpreted in an idealized or overly formal sense unless expressly so defined herein.

Some of the embodiments contemplated herein will now be described more fully with reference to accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

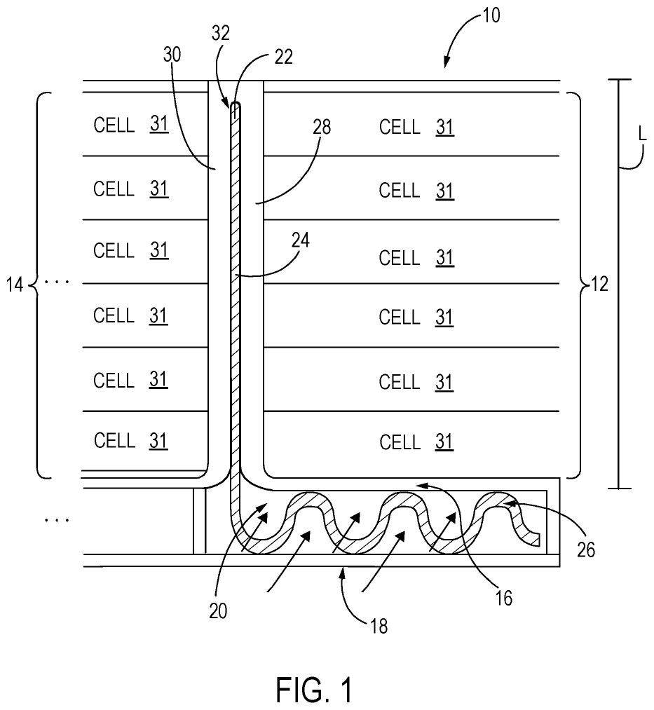

Although the subject matter described herein may be implemented in any appropriate type of battery cooling system using any suitable components, the embodiments disclosed herein are described in relation to a fluid cooling system, such as a liquid coolant cooling system (e.g., for lithium-ion battery cells or any other type of battery cells) as illustrated in FIGS. 1-7. The term “fluid” may refer to a substance (such as a liquid or gas) which may flow or conform to a volume defined by its container. In some embodiments, fluid may be air, a refrigerant, a coolant, etc.

Some embodiments include a thermal management system which provides a thermal management solution. In one or more embodiments, the thermal management system is an electrical vehicle (EV) thermal management system such as a thermal management system that is comprised in the EV and configured to provide cooling of one or more battery packs of the EV. The thermal management system of the present disclosure is beneficial at least because the thermal management system has a less complex structure and a less complex construction method, as compared to existing EV thermal management systems,. For example, the simpler structure of the thermal management system comprises a housing (e.g., molded housing),, cooling channels, and a fluid cooling manifold with a radiator (i.e., thermal exchanger).

In some embodiments, cooling channels are molded into a bottom of the housing. In some embodiments, stamped radiators are inserted into a molded housing to provide a cooling path from the heat generating elements (battery cells and/or heat generating electrical components) to the cooling fluid. In some embodiments, safety may be improved (when compared to existing systems) by not having a failure mode where cooling fluid (e.g., coolant) touches the battery cells, as may be the case in cooling systems where cooling fluid (e.g., liquid coolant) directly contacts the battery cells.

Some embodiments include a battery cooling system 10 (hereinafter also referred to as system 10), as illustrated in FIG. 1. The system 10 includes a first stack 12 of battery cells and a second stack 14 of battery cells, housed within a battery housing 16. The first and second stacks are not limited to being arranged in a stack and may be referred to as a group such as a group of cells. In one or more embodiments, the cooling fluid flow channel 20 may be coupled (e.g., releasably coupled) to at least portion of the battery housing 16 or be defined by at least a portion of the battery housing 16 and/or any other battery component such as base plate 18. In some embodiments, the base plate 18 is coupled to the bottom of the battery housing 16. In some other embodiments, the bottom of the battery housing and the base plate 18 define the cooling fluid flow channel 20. In some other embodiments, the cooling fluid flow channel 20 may be molded into the battery housing 16, e.g., molded into a bottom portion of the battery housing 16.

In some embodiments, the cooling fluid flow channel 20 is arranged through a single-level of the battery housing 16, e.g., bottom of the battery housing 16 (and/or base plate 18). In other embodiments, the cooling fluid flow channel 20 is arranged through multiple hierarchical levels of the battery housing 16. For example, in one hierarchical level arrangement, the cooling fluid flow channel 20 may be defined by the bottom of the battery housing 16 and base plate 18. In another hierarchical level arrangement, the cooling fluid flow channel 20 may be defined by lateral sides (or walls) of battery stacks 12, 14 and the battery housing 16. Yet, in another hierarchical level arrangement, the cooling fluid flow channel 20 may be defined by top portions of the battery housing 16 and a cover coupled (e.g., sealed) to the top portions of the housing, etc. In other words, in alternative embodiments, the cooling fluid flow channel 20 may be defined by and/or extend to other portions of the battery housing 16, such as a top portion and/or one or more lateral sides of the battery housing 16.

In some embodiments, a one-way valve is integrated into the cooling system loop, i.e., in fluid communication with the cooling fluid flow channel 20 and/or cooling fluid flow channel 20 inlet to enable emergency responders to provide additional cooling directly to the energy storage system thermal management when responding to an accident.

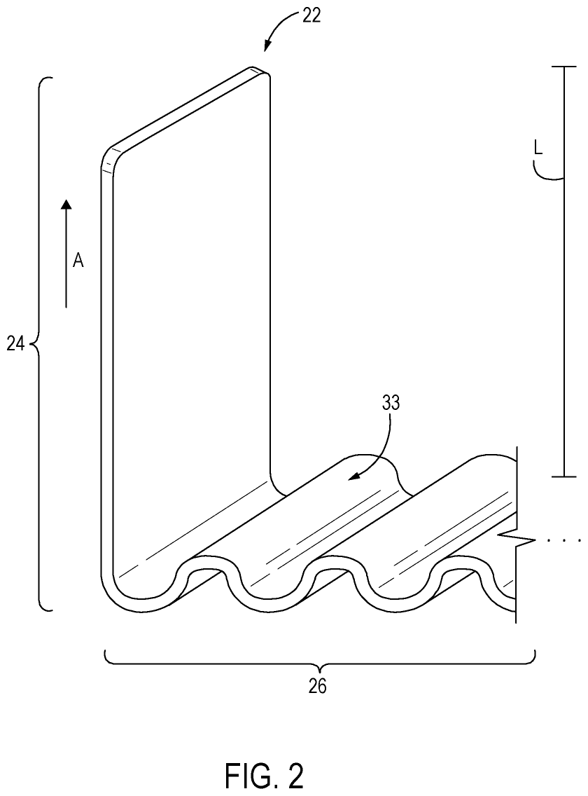

The system 10 further includes a thermal exchanger 22, which may operate as a radiator. The thermal exchanger 22 includes a thermal exchanger leg portion 24 and a thermal exchanger foot portion 26. The thermal exchanger foot portion 26 and the thermal exchanger leg portion 24 may form an L-shaped structure. In some embodiments, the base plate 18 may be assembled to the battery housing 16 after press fitting the thermal exchangers 22 into e.g., L-shaped receivers defined by the battery housing 16, as shown in FIGS. 1 and 2. In some embodiments, a material such as adhesive and/or sealant may be applied around thermal exchanger 22 to further limit the risk of fluid leaks with the receiver. The thermal exchanger 22 may be made of a thermally conductive material, such as metal, e.g., aluminum. The thermal exchanger 22 in some embodiments, may for example be a stamped metallic structure, a molded metallic structure or even a cut extruded metallic structure.

The thermal exchanger leg portion 24 is disposed between and thermally coupled to adjacent lateral sides of the first and second stacks 12, 14. The thermal exchanger leg portion 24 may have a leg length, L, that extends from a top to a bottom of the adjacent lateral sides to transfer heat energy from the battery cells of the first and second stacks 12, 14 to the thermal exchanger foot portion 26. In some embodiments, the thermal exchanger leg portion 24 has a planar surface shape. The thermal exchanger leg portion 24 is preferably sized to be press fit into the battery housing 16 between the first and second stacks 12, 14 to transfer heat from the battery cells toward the cooling fluid flow channel 20 and to be retained in place during manufacturing and/or operation and/or service of the battery. In some embodiments, the battery housing 16 may also be made of and/or contain a thermally conductive material so that heat generated from the battery cells can be transferred efficiently to the thermal exchanger leg portion 24 (and/or thermal exchanger foot portion 26). In some embodiments, the battery housing 16 may be or include a polymer, e.g., plastic.

In some embodiments, the thermal exchanger leg portion 24 is disposed external to the cooling fluid flow channel 20, being disposed between opposite walls 28, 30 of the battery housing 16, which walls 28, 30 house the first and second stacks 12, 14, respectively. The battery housing 16 may be arranged to define a leg portion receiver 32 that is sized, shaped and configured to receive a respective thermal exchanger leg portion 24 therein, via e.g., press fitting assembly. As noted above, in some embodiments, adhesive and/or sealant may be applied around thermal exchanger 22 to further limit the risk of fluid leaks with the receiver.

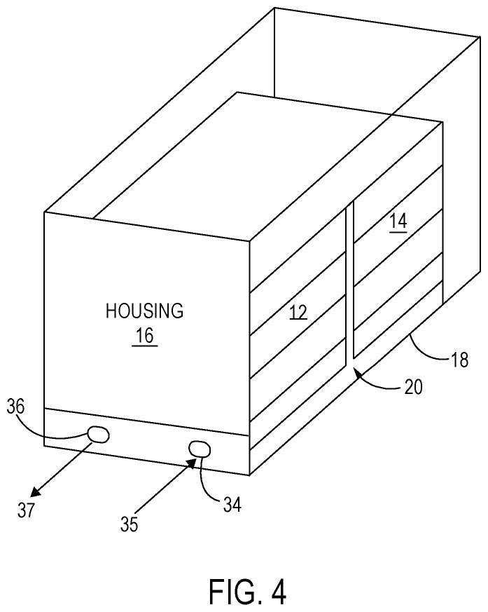

The battery housing 16 houses the battery cells 31 and, along with the base plate 18, encloses the battery cells 31 and the cooling fluid flow channel 20. The battery housing 16 may define at least one cooling fluid inlet port 34 and at least one cooling fluid outlet port 36, as shown in FIG. 4, through which a cooling fluid is circulated through the cooling fluid flow channel 20. In some embodiments, the battery cells 31 may be Li-Ion battery cells. The thermal exchanger foot portion 26 is disposed within and thermally coupled to the cooling fluid flow channel 20 that is defined by the battery housing 16. In some embodiments, the thermal exchanger foot portion 26 is arranged to directly physically contact a cooling fluid flowing through the cooling fluid flow channel 20. In some other embodiments, the thermal exchanger foot portion 26 is arranged to indirectly physically contact (e.g., via another material, element, component, film, layer, etc.) a cooling fluid flowing through the cooling fluid flow channel 20.

In some embodiments, as shown in FIG. 2, the thermal exchanger leg portion 24 is arranged to be press fit (e.g., in a direction A) into the battery housing 16 between the first and second stacks 12, 14 to transfer heat from the battery cells 31 toward the thermal exchanger foot portion 26. The thermal exchanger 22 (and/or thermal exchanger leg portion 24 and/or thermal exchanger foot portion 26) may be stamped (e.g., for ease of manufacturing, simplicity of manufacturing, operation, and maintenance) and/or made of one or more materials having a predetermined thermal conductivity (e.g., high thermal conductivity) such as aluminum.

The thermal exchanger foot portion 26 may include a cooling fin element 33 configured to transfer heat energy from the thermal exchanger leg portion 24 to the cooling fluid flow channel 20. In some embodiments, the cooling fin element 33 is sized, shaped and/or configured to increase the surface area of the thermal exchanger foot portion 26 arranged to be in contact with the cooling fluid (e.g., in the cooling fluid flow channel 20). Thermal conductivity of the thermal exchanger foot portion 26 increases when its surface area is increased, and thus, a greater amount of thermal energy per unit of time can be transferred to the cooling fluid and/or cooling fluid flow channel 20. Thus, the thermal energy from battery stacks 12, 14 that is received by the thermal exchanger leg portion 24 and transferred to the thermal exchanger foot portion 26 can be conducted (e.g., released, transferred) to the cooling fluid at a faster rate (than without the increased surface area). Put differently, the surface area of the thermal exchanger foot portion 26 may be increased to increase the cooling rate of the battery packs. In a nonlimiting example, when the surface area of the thermal exchanger foot portion 26 is increased by a predetermined percentage, X, thermal conductivity is increased by a factor, Y, and the cooling rate of the battery stacks 12, 14 is increased by a factor, Z.

In some embodiments, the cooling fin element 33 may have a non-planar waveform surface shape, or other shape, configured to increase the surface area of the exchanger foot portion 26 within a predefined volume (i.e., in the cooling fluid flow channel 20). The non-planar waveform surface shape may be uniform or non-uniform. A non-uniform waveform shape may include waves (i.e., fins) having a greater amplitude (e.g., displacement) than other waves (i.e., fins) of the exchanger leg portion 24. In some embodiments, the exchanger leg portion 24 comprises a first cooling fin element 33a (e.g., wave of a waveform, fin), a second cooling fin element 33b (e.g., wave of a waveform, fin), each having a same width. The first cooling fin element 33a has a greater amplitude than the amplitude of the second cooling fin element 33b. The surface area corresponding to each one of the first and second cooling fin elements 33a, 33b is directly proportional to the respective amplitude. Thus, in this nonlimiting example, the surface area of the first cooling fin element 33a is greater than the surface area of the second cooling fin element 33b. In addition, the thermal conductivity of the first cooling fin element 33a is greater than the thermal conductivity of the second cooling fin element 33b. Further, the overall surface area and/or thermal conductivity of the exchanger leg portion 24 is increased when having a non-planar waveform surface shape (e.g., when compared to a flat shape).

In another embodiment, the exchanger leg portion 24 (having a non-uniform waveform shape) has a plurality of cooling fin elements 33. Each cooling fin element 33 corresponds to a peak of the non-uniform waveform. Each peak of the non-uniform waveform shape has a corresponding amplitude, where the first peak is the peak that is closest to the exchanger leg portion 24, and the last peak is the peak furthest from the exchanger leg portion. In a nonlimiting example, the amplitude of each peak decreases when compared to a peak that is closer to the thermal exchanger leg portion 24. That is, the amplitude of the peaks decreases as the distance between the peak and the thermal exchanger leg portion 24 increases. Thus, the first peak offers a greater surface area than other peaks, e.g., so that the thermal energy being received from the thermal exchanger leg portion 24 can be quickly released to the cooling fluid.

Other shapes of the cooling fin element 33 may include rectangular fins, tubular fins, radial fins, a mesh, or any other shape. In a nonlimiting example, the thermal exchanger foot portion 26 comprises a plurality of cooling fin elements 33 (e.g., planar fins) that protrude or extend away from the thermal exchanger foot portion 26 into the cooling fluid flow channel 20 (and/or cooling fluid). Each planar fin has a surface area. The location, size, and surface area of each planar fin may depend on one or more characteristics of the cooling fluid flow channel 20 and cooling fluid. For example, some characteristics may include shape, volume, and material of the cooling fluid flow channel 20, location of inlets/outlets of cooling fluid with respect to the thermal exchanger foot portion 26 and/or cooling fin elements 33 (e.g., planar fins), characteristics of the cooling fluid (e.g., freezing point, boiling point, pH, composition, flow rate at which the cooling fluid travels through the cooling fluid flow channel 20, etc.). In some embodiments, the angle at cooling fin element faces the flow vector of the cooling fluid is dynamically adjustable based on the characteristics of the cooling fluid flow channel 20 and/or cooling fluid, temperature of battery cells 31, battery stacks 12, 14, cooling fluid flow rate, etc.

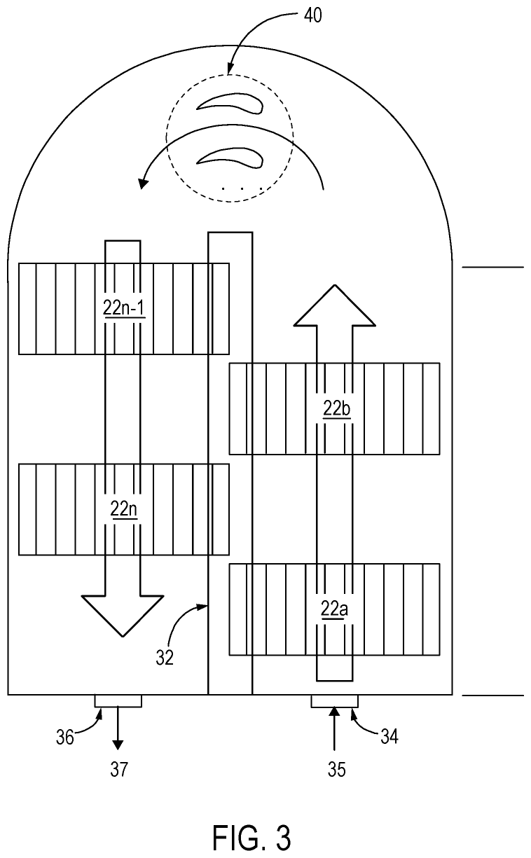

FIG. 3 is a schematic diagram illustrating a plan view of a bottom of the battery cooling system 10 according to one embodiment of the present disclosure. As illustrated in FIG. 3, the battery cooling system 10 may include a plurality of stacks 12, 14 of battery cells and a plurality of thermal exchangers 22a-n (where ‘a’ is 1 and ‘n’ can be any number greater than 1) arranged inside the battery housing 16. Each thermal exchanger 22 is disposed to thermally couple, e.g., in a heat exchanging relationship, to one or more stacks (e.g., every other stack) in the plurality of stacks 12, 14 such as in an alternating arrangement. In some embodiments, alternating thermal exchangers/radiators provides a consistent average temperature of cooling fluid to the battery cells. In alternative embodiments, the thermal exchanger 22 may be disposed to thermally couple to more stacks such as to every stack.

Battery cooling system 10 may further include cooling fluid ports (or thermal management fluid ports) such as cooling fluid inlet port 34 and cooling fluid outlet port 36. In some embodiments, cooling fluid inlet port 34 is arranged to receive a thermal management fluid such as a cooling fluid (i.e., entering cooling fluid 35). In some embodiments, cooling fluid outlet port 36 is arranged to release the thermal management fluid such as the cooling fluid (i.e., released cooling fluid 36, which may be the same as entering cooling fluid 35 but having absorbed thermal energy from thermal exchanger 22. In some embodiments, the functions of cooling fluid inlet/outlet ports 34, 36 may be reversed such that cooling fluid outlet port 36 provides the functions of cooling fluid inlet port 34, and vice versa. Cooling fluid inlet/outlet ports 34, 36 may be in fluid communication with one or more components of battery cooling system 10 such as any of the components shown in FIGS. 1-7. Further, battery cooling system 10 may include one or more flow directors 40 arranged to monitor and/or control and/or indicate a direction at which the thermal management fluid (e.g., cooling fluid, coolant) travels within the battery cooling system. In a nonlimiting example, flow directors 40 may be dynamically adjusted based on temperature (e.g., measured temperature) of one or more components of the battery, e.g., the position of the flow directors 40 may be changed causing the cooling fluid to be directed to areas where temperature has exceeded (or is expected to exceed) a predetermined temperature threshold. The position adjustment of flow directors 40 may be performed manually or automatically (e.g., via sensor, controller, expansion/contraction of metals such as a bimetallic strip/coil). In another nonlimiting example, flow directors 40 are fixed flow directors, e.g., the position of the flow directors 40 with respect to one or more components of the battery such as the battery housing 16 is unchangeable once manufactured.

Further, each flow director 40 may have one or more shapes having one or more characteristics such as airfoil/hydrofoil fluid dynamics. For example, flow directors 40 may be shaped as an airfoil (e.g., when cooling fluid is a gas) or a hydrofoil (e.g., when cooling fluid is a liquid). Being shaped as an airfoil or hydrofoil may force the particles of the cooling fluid to travel a similar speeds or flows over and under the flow director such that uniform flow is achieved between the cooling fluid that flows over and under the flow directors 40 even though the flow path is curved. In addition, the shape of the flow directors 40 may be determined based on the cooling fluid characteristics and/or characteristics of the battery cooling system 10 such as acceptable pressure drop of the battery cooling system 10. Pressure drop may refer to a difference of pressures of the cooling fluid between two points of the battery cooling system 10 (e.g., as cooling fluid inlet port 34 and cooling fluid outlet port 36). The pressure drop may correspond to a flow rate of the cooling fluid which may be adjustable by the flow directors 40.

FIG. 4 is a perspective view of the battery cooling system 10 according to one embodiment of the present disclosure. The battery cooling system 10 shown is in an assembled arrangement and may comprise one or more of the battery housing 16 (comprising stacks 12, 14), base plate 18, cooling fluid flow channel 20, and cooling fluid inlet/outlet ports 34, 36 (which may be referred to as cooling fluid inlet/outlet ports).

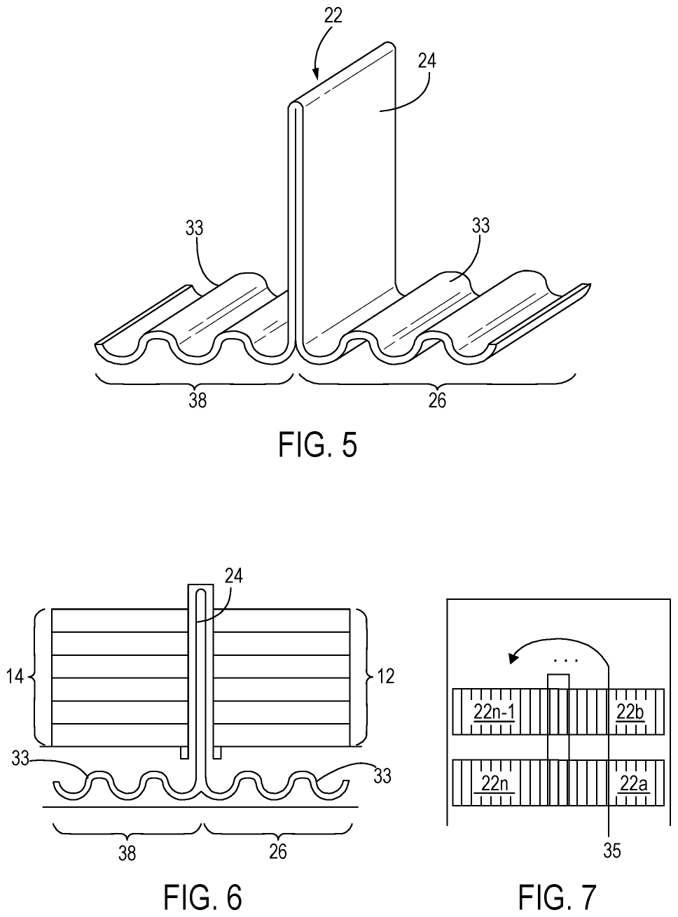

Referring now primarily to FIGS. 5-7, an example of a second embodiment of the system 10 is shown. The thermal exchanger 22 includes a single leg portion and two (2) additional portions (i.e., foot portions), although more than two additional portions may be included. Stated another way, the thermal exchanger 22 of FIGS. 5-7 further include a second thermal exchanger foot portion 38. The second thermal exchanger foot portion 38 may be arranged opposite (or in any other direction with respect) to the first, thermal exchanger foot portion 26. The first thermal exchanger foot portion 26 may be considered to extend away from the thermal exchanger leg portion 24 in a first direction and the second thermal exchanger foot portion 38 extends away from the thermal exchanger leg portion 24 in a second direction that is opposite to the first direction, as can be seen in FIGS. 5 and 6. The first and second directions are not limited to being opposite and may be different without being opposite. The thermal exchanger foot portions 26, 38 and the thermal exchanger leg portion 24 may form a T-shaped structure (rather than the L-shaped structure provided in the first embodiment described with reference to FIGS. 1-4). Although the structure is modified slightly in the second embodiment, the thermal exchanging properties may be similar or the same as described in the first embodiment. In some embodiments, the second embodiment comprises at least two thermal exchangers 22 of the first embodiment, where the two thermal exchangers 22 are formed in a single unitary construction, integrated, coupled, and/or connected by one or more connecting elements, etc.

In the second embodiment, the system 10 may include a plurality of stacks 12, 14 of battery cells and a plurality of thermal exchangers 22a-n (where ‘a’ is 1 and ‘n’ can be any number greater than 1) arranged inside a battery housing 16. However, unlike in the example alternating arrangement described with respect to the first embodiment, each thermal exchanger 22 in the second embodiment may be disposed to thermally couple, in a heat exchanging relationship, to each stack in the plurality of stacks 12, 14 in a non-alternating arrangement, as shown in FIG. 7. In other words, in one version of this embodiment, the thermal exchanger 22 is “T shaped” (shown in FIG. 7 as an inverted T shape). For example, the first thermal exchanger foot portion 26 (of thermal exchanger 22) may be arranged to thermally couple, in a heat exchanging relationship, to a portion of the first stack 12, while the second thermal exchanger foot portion 38 may be arranged to thermally couple, in a heat exchanging relationship, to a portion of the second stack 14. In some embodiments, thermal exchangers 22a, 22n may comprise a single thermal exchanger. Similarly, thermal exchangers 22b, 22n-1 may comprise a single thermal exchanger.

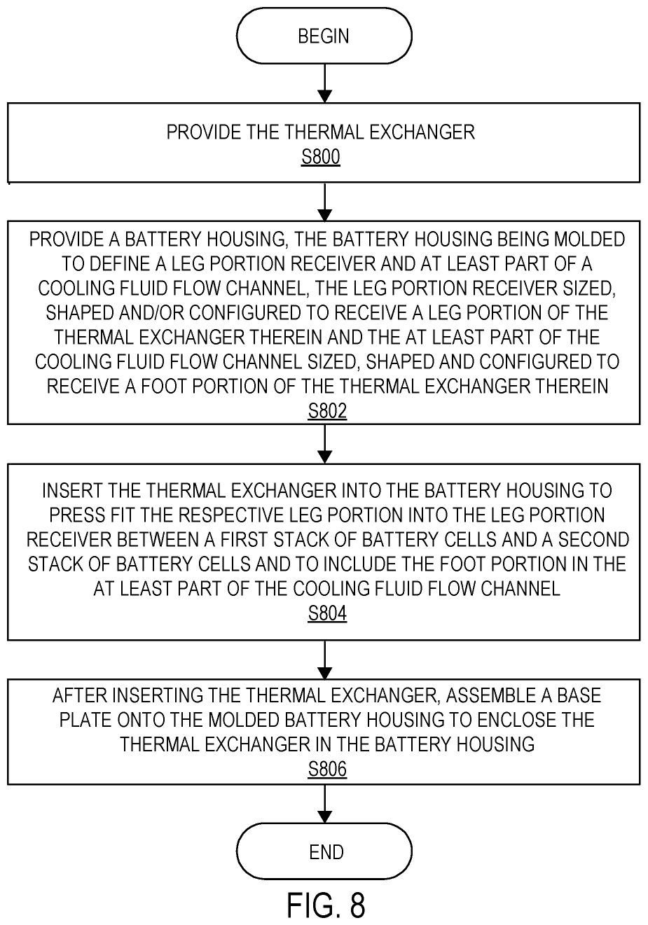

Referring now primarily to FIG. 8, an example method of manufacturing is described. In step S800, the method includes providing the thermal exchanger 22 and, in step S802, providing the battery housing 16. The battery housing 16 is molded to define a leg portion receiver 32 and at least part of a cooling fluid flow channel 20. The leg portion receiver 32 is sized, shaped and/or configured to receive (and./or couple to) the thermal exchanger leg portion 24 therein, e.g., via press fitting. Press fitting may refer to coupling and/or fastening of two parts that is achieved by excreting at least a predetermined force, friction, etc. The cooling fluid flow channel 20 is sized, shaped and/or configured to receive the thermal exchanger foot portion 26 therein, while still allowing cooling fluid (e.g., coolant liquid) to flow through the cooling fluid flow channel 20, e.g., from the cooling fluid inlet port 34 to the cooling fluid outlet port 36 in a circulating manner.

In step S804, the method includes inserting the thermal exchanger 22 into the battery housing 16 to press fit the respective thermal exchanger leg portion 24 into the leg portion receiver 32 between a first stack 12 of battery cells and a second stack 14 of battery cells and to include the thermal exchanger foot portion 26 in the cooling fluid flow channel 20. In step S806, the method includes, after inserting the thermal exchanger 22, assembling the base plate 18 onto the molded battery housing 16 to enclose the thermal exchanger 22 and the cooling fluid flow channel 20 in the battery housing 16. For example, the base plate 18 may be assembled to the battery housing 16 after press fitting the thermal exchanger 22 into the battery housing 16. Such assembly can include gluing, welding or any other arrangement for coupling (e.g., releasably coupling or affixing) the base plate 18 to the battery housing 16 to create a fluid tight seal and path through the cooling fluid flow channel 20.

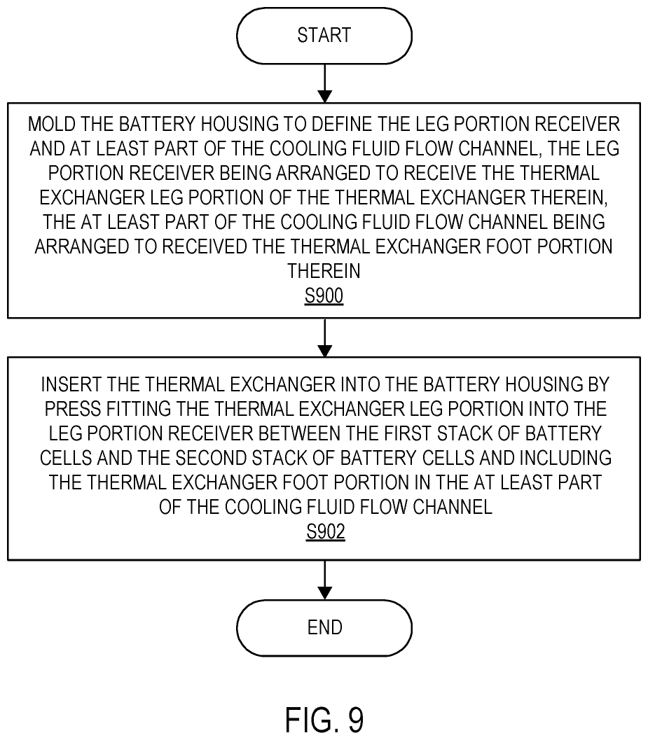

Referring now primarily to FIG. 9, another example method of manufacturing is described. More specifically, a method of manufacturing a battery cooling system 10 for a battery is described. The battery cooling system 10 comprises a cooling fluid flow channel 20, a battery housing 16, and a first stack 12 and a second stack 14 of battery cells 31. The battery housing 16 comprises a leg portion receiver 32. The battery cooling system 10 comprises a thermal exchanger 22. The thermal exchanger 22 comprises a thermal exchanger leg portion 24 and a thermal exchanger foot portion 26. The method comprises, at step S900, molding the battery housing 16 to define the leg portion receiver 32 and at least part of the cooling fluid flow channel 20. The leg portion receiver 32 is arranged to receive the thermal exchanger leg portion 24 of the thermal exchanger 22 therein. The at least part of the cooling fluid flow channel 20 is arranged to receive the thermal exchanger foot portion 26 therein. The method further comprises, at step S902, inserting the thermal exchanger 22 into the battery housing 16 by press fitting the thermal exchanger leg portion 24 into the leg portion receiver 32 between the first stack 12 of battery cells 31 and the second stack 14 of battery cells 31 and including the thermal exchanger foot portion 26 in the at least part of the cooling fluid flow channel 20.

In some embodiments, the battery cooling system 10 further includes one or more of a base plate 18, a cooling fluid inlet port 34, and a cooling fluid outlet port 36. The method further includes one or more of steps: (A) after inserting the thermal exchanger 22, coupling the base plate 18 to the molded battery housing 16, where the coupling of the base plate 18 encloses the thermal exchanger 22 in the battery housing 16 and further defines the cooling fluid flow channel 20; (B) inserting the first stack 12 and the second stack 14 in the battery housing 16, where the inserted first and second stacks 12, 14 have adjacent sides facing the thermal exchanger leg portion 24 of the thermal exchanger 22; and (C) one of forming on, coupling to, and molding on the battery housing 16 the cooling fluid inlet port 34 and the cooling fluid outlet port 36. The cooling fluid inlet port 34 and the cooling fluid outlet port 36 are in fluid communication with the cooling fluid flow channel 20 and at least the thermal exchanger leg portion 26.

The following is a nonlimiting list of example embodiments:
1. A battery cooling system 10 comprising:
a first stack 12 of battery cells 31 and a second stack 14 of battery cells 31; and
a thermal exchanger 22 comprising a thermal exchanger leg portion 24 and a thermal exchanger foot portion 26,
   the thermal exchanger leg portion 24 being disposed between and thermally coupled to adjacent lateral sides of the first and second stacks 12, 14, and the thermal exchanger leg portion 24 comprising a leg length that extends from a top to a bottom of the adjacent lateral sides to transfer heat energy from the battery cells 31 of the first and second stacks 12, 14 to the thermal exchanger foot portion 26, and
   the thermal exchanger foot portion 26 being disposed within and thermally coupled to a cooling fluid flow channel 20 defined by a battery housing 16, and the thermal exchanger foot portion 26 comprising a cooling fin element 33 configured to transfer heat energy from the thermal exchanger leg portion 24 into the cooling fluid flow channel 20.
2. The battery cooling system 10 of Embodiment 1, wherein the thermal exchanger leg portion 24 has a planar surface shape.
3. The battery cooling system 10 of any one of Embodiments 1 and 2, wherein the thermal exchanger foot portion 26 has a non-planar waveform surface shape.
4. The battery cooling system 10 of any one of Embodiments 1-3, wherein the thermal exchanger 22 is a stamped thermally conductive structure.
5. The battery cooling system 10 of any one of Embodiments 1-4, further comprising at least one of an adhesive and a sealant, the at least one of the adhesive and the sealing being applied around the thermal exchanger 22.
6. A radiator for a battery, the radiator comprising:
a thermal exchanger 22 comprising a thermal exchanger leg portion 24 and a thermal exchanger foot portion 26,
   the thermal exchanger leg portion 24 comprising a planar surface shape configured to be disposed between and thermally coupled to adjacent lateral sides of a first and a second stack 14 of battery cells 31, and the thermal exchanger leg portion 24 comprising a leg length configured to extend from a top to a bottom of the adjacent lateral sides to transfer heat energy from the battery cells 31 of the first and second stacks 12, 14 to the thermal exchanger foot portion 26, and
   the thermal exchanger foot portion 26 comprising a cooling fin element 33 having a non-planar waveform surface shape configured to transfer heat energy from the thermal exchanger leg portion 24 into a cooling fluid flow channel 20.
7. The radiator of Embodiment 6, wherein the thermal exchanger foot portion 26 and the thermal exchanger leg portion 24 form an L-shaped structure.
8. The radiator of any one of Embodiments 6 and 7, wherein the thermal exchanger foot portion 26 extends away from the thermal exchanger leg portion 24 in a first direction and the thermal exchanger 22 further comprises a second thermal exchanger foot portion 38 that extends away from the thermal exchanger leg portion 24 in a second direction that is opposite to the first direction.
9. The radiator of any one of Embodiments 6-7, wherein the thermal exchanger foot portions 26, 38, and the thermal exchanger leg portion 24 form a T-shaped structure.
10. The radiator of any one of Embodiments 6-9, further comprising at least one of an adhesive and a sealant, the at least one of the adhesive and the sealing being applied around the thermal exchanger 22.
11. A method of manufacturing and/or assembling a battery cooling system 10, the method comprising:
providing the thermal exchanger 22 of any one of Embodiments 1-10;
providing a battery housing 16, the battery housing 16 being molded to define a leg portion receiver and at least part of a cooling fluid flow channel 20, the leg portion receiver sized, shaped and/or configured to receive a leg portion of the thermal exchanger 22 therein and the at least part of the cooling fluid flow channel 20 sized, shaped and configured to receive a foot portion of the thermal exchanger 22 therein;
inserting the thermal exchanger 22 into the battery housing 16 to press fit the respective leg portion into the leg portion receiver between a first stack 12 of battery cells 31 and a second stack 14 of battery cells 31 and to include the foot portion in the at least part of the cooling fluid flow channel 20; and
after inserting the thermal exchanger 22, assembling a base plate onto the molded battery housing 16 to enclose the thermal exchanger 22 in the battery housing 16.

Some embodiments are described herein with reference to flowchart illustrations and/or block diagrams of methods of manufacturing and/or assembling. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following claims.

1. A thermal exchanger for a battery comprising one or both of a first stack and a second stack of battery cells, the thermal exchanger comprising a thermal exchanger leg portion and a thermal exchanger foot portion:
the thermal exchanger leg portion being positionable to thermally couple to one or both of the first stack and the second stack of battery cells, and the thermal exchanger leg portion being arranged to transfer thermal energy from one or both of the first stack and second stack to the thermal exchanger foot portion.

2. The thermal exchanger of claim 1, wherein the thermal exchanger leg portion comprises a planar surface positionable between and thermally coupled to the first stack and the second stack of battery cells.

3. The thermal exchanger of claim 1, wherein the thermal exchanger leg portion comprises a leg length and leg width configured to provide a stack contact area to contact at least a portion of one or both of the first stack and the second stack.

4. The thermal exchanger of claim 1, wherein the thermal exchanger foot portion comprises a cooling fin element having a non-planar waveform surface shape.

5. The thermal exchanger of claim 1, wherein the thermal exchanger foot portion and the thermal exchanger leg portion form one of an L-shaped structure and a T-shaped structure.

6. The thermal exchanger of claim 1, wherein the thermal exchanger foot portion comprises a first thermal exchanger foot portion and a second thermal exchanger foot portion, the first thermal exchanger foot portion extending away from the thermal exchanger leg portion in a first direction, the second thermal exchanger foot portion extending away from the thermal exchanger leg portion in a second direction different from the first direction.

7. The thermal exchanger of claim 1, wherein the thermal exchanger further comprises one or both of an adhesive and a sealant, the one or both of the adhesive and the sealant being applied on the thermal exchanger.

8. The thermal exchanger of claim 1, wherein the thermal exchanger foot portion is configured to transfer the thermal energy from the thermal exchanger leg portion to a cooling fluid flow channel of the battery.

9. A battery cooling system comprising:
one or both of a first stack of battery cells and a second stack of battery cells; and
a thermal exchanger comprising a thermal exchanger leg portion and a thermal exchanger foot portion, the thermal exchanger leg portion being thermally coupled to the one or both of the first stack and the second stack of battery cells, the thermal exchanger leg portion being arranged to transfer thermal energy from one or both of the first stack and second stack to the thermal exchanger foot portion; and
a battery housing, the battery housing defining at least part of a cooling fluid flow channel, the thermal exchanger and the one or both of the first stack and the second stack being positioned within the battery housing, the thermal exchanger foot portion being positioned within cooling fluid flow channel.

10. The battery cooling system of claim 9, wherein the battery cooling system comprises both of the first stack and the second stack of battery cells having adjacent lateral sides, and the thermal exchanger leg portion is disposed between the first stack and the second stack of battery cells and thermally coupled to the adjacent lateral sides.

11. The battery cooling system of claim 10, wherein the adjacent lateral sides comprise a top and a bottom, and the thermal exchanger leg portion comprises a leg length that extends from the top to the bottom of the adjacent lateral sides to transfer thermal energy from the battery cells of the first and second stacks to the thermal exchanger foot portion.

12. The battery cooling system of claim 9, wherein the thermal exchanger leg portion comprises a planar surface disposed between and thermally coupled to the first stack and the second stack of battery cells (31).

13. The battery cooling system of claim 9, wherein the battery cooling system further includes a cooling fluid, the cooling fluid flow channel receiving the cooling fluid.

14. The battery cooling system of claim 13, wherein the thermal exchanger foot portion comprises a cooling fin element arranged to transfer thermal energy from the thermal exchanger leg portion into one or both of the cooling fluid and the cooling fluid flow channel.

15. The battery cooling system of claim 9, wherein the battery housing further comprises a base plate, the battery housing and the and the base plate defining the cooling fluid flow channel.

16. The battery cooling system of claim 9, wherein the battery housing defines a leg portion receiver receiving the thermal exchanger leg portion and thermally coupling the thermal exchanger leg portion to the one or both of the first and second stacks.

17. The battery cooling system of claim 9, wherein the battery cooling system further includes a flow director arranged to control a cooling fluid flow direction.

18. The battery cooling system of claim 9, wherein the battery cooling system further includes a cooling fluid inlet port and a cooling fluid outlet port arranged to receive and release cooling fluid, respectively.

19. A method of manufacturing a battery cooling system for a battery comprising a cooling fluid flow channel, a battery housing, and a first stack and a second stack of battery cells, the battery housing comprising a leg portion receiver, the battery cooling system comprising a thermal exchanger, the thermal exchanger comprising a thermal exchanger leg portion and a thermal exchanger foot portion, the method comprising:
molding the battery housing to define the leg portion receiver and at least part of the cooling fluid flow channel, the leg portion receiver being arranged to receive the thermal exchanger leg portion of the thermal exchanger therein, the at least part of the cooling fluid flow channel being arranged to receive the thermal exchanger foot portion therein; and
inserting the thermal exchanger into the battery housing by press fitting the thermal exchanger leg portion into the leg portion receiver between the first stack of battery cells and the second stack of battery cells and including the thermal exchanger foot portion in the at least part of the cooling fluid flow channel.

19. The method of claim 19, wherein the battery cooling system further includes one or more of a base plate, a cooling fluid inlet port, and a cooling fluid outlet port, and the method further includes one or more of:
after inserting the thermal exchanger, coupling the base plate to the molded battery housing, the coupling of the base plate enclosing the thermal exchanger in the battery housing and further defining the cooling fluid flow channel;
inserting the first stack and the second stack in the battery housing, the inserted first and second stacks having adjacent sides facing the thermal exchanger leg portion of the thermal exchanger; and
one of forming on, coupling to, and molding on the battery housing the cooling fluid inlet port and the cooling fluid outlet port, the cooling fluid inlet port and the cooling fluid outlet port being in fluid communication with the cooling fluid flow channel and at least the thermal exchanger leg portion.
